(19) United States
(12) Patent Application Publication
(10) Pub. No.: US 2007/0132640 A1
(43) Pub. Date: Jun. 14, 2007

(54) Planar inverted f antenna tapered type pifa with corrugation

(75) Inventors: Byung-Chan Kim, Daejon (KR); Je-Hoon Yun, Daejon (KR); Hyung-Do Choi, Seoul (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTIT, Daejon (KR)

(21) Appl. No.: 10/575,347

(22) PCT Filed: Oct. 15, 2004
(86) PCT No.: PCT/KR04/02654

§ 371 Date: Apr. 11, 2006

(30) Foreign Application Priority Data
Oct. 16, 2003 (KR) 10-2003-0072082

(51) Int. Cl. H01Q 1/38

(52) U.S. Cl. 343/700 MS

(57) ABSTRACT

A planar inverted F antenna having a radiation patch having an asymmetric shape of linearly-tapered rectangle with a plurality of corrugated hollows is disclosed. The planar inverted F antenna having a radiation patch, includes: a first radiation patch for radiating a signal; a ground plate for grounding the first radiation patch; a feeding line for supplying an electric power to the first radiation patch; a short plate having one side coupled to the first radiation patch and other side coupled to the ground plate for shorting the first radiation patch, wherein the first radiation patch having an asymmetrical shape of linearly tapered rectangle and has one or more corrugated hollows.

### TECHNICAL FIELD

The present invention relates to a radiation patch for a planar inverted F antenna; and, more particularly, to the radiation patch having an asymmetric shape of linearly-tapered rectangle with a plurality of corrugated hollows for a planar inverted F antenna in order to provide wide bandwidth characteristic.

### BACKGROUND ART

A planar inverted F antenna is a modified microstrip antenna having a shape of inverted F.

FIG. 1 is a diagram illustrating a conventional planar inverted F antenna in accordance with a prior art.

Referring to FIG. 1, the conventional planar inverted F antenna 100 includes a rectangular radiation patch 110 having a size of a length Lₚ and width Wₚ, a shorting plate 120, a feeding line 130 and a ground plane 140.

The shorting plate 120 is attached between the ground plane 140 and the rectangular radiation patch 110. The feeding line 130 supplies electric power to the rectangular radiation patch 110.

The planar inverted F antenna has been widely used in a wireless communication field since its advantages such as simple structure, low profile, easy to manufacture and low cost.

However, the conventional planar inverted F antenna has a size of ¼ of a wavelength, which is smaller than a general size of conventional microstrip antenna, which is ½ of a wavelength, but the conventional planar inverted F antenna is still large to be implemented into a mobile terminal. Accordingly, there has been demanded a technology reducing the size of the conventional planar inverted F antenna Furthermore, a technology maintaining or widening a bandwidth of the conventional planar inverted F antenna have been also demanded since the bandwidth of the conventional planar inverted F antenna is also reduced in correspondence to the size of the conventional planar inverted F antenna.

For overcoming the above mentioned drawback, Terry Kinchun Lo and Yeongming Whang discloses a technology for widening a bandwidth by punching various shapes of slots such as shapes of L or U and uses various feeding methods. The bandwidth is widened according to a length and a width of the slots. However, it is getting more complicated for designing the conventional planar inverted F antenna

Furthermore, Kathleen L. Virga and Yahya Rahmat-Smaii disclose another technology for widening a bandwidth in “Low Profile Enhanced-Bandwidth PIFA antenna for Wireless Communication Packaging”, IEEE TRANSACTION ON MICROWAVE THEORY AND TECHNIQUES, vol. 45, No. 10, pp 1879-1888, October, 1997. For widening the frequency bandwidth, Kathleen and Yahya implements additional patches to an antenna or two patches connected by timing diode as a radiation device. As a result, a frequency bandwidth is getting wider, e.g., 14% of bandwidth is increased than the linear antenna or dipole antenna. However, the antenna introduced by Kathleen and Yahya is complicated and a manufacturing cost is increased.

### DISCLOSURE OF INVENTION

Technical Problem

It is, therefore, an object of the present invention to provide a planar inverted F antenna for widening a frequency bandwidth by providing a linearly tapered rectangular shape of radiation patch and forming a predetermined number of corrugated hollows having a predetermined length and width on the radiation patch.

It is another object of the present invention to provide a planar inverted F antenna for widening a frequency bandwidth and obtaining flexibility of antenna design by providing a radiation patch having an asymmetric shape of linearly tapered rectangular having a plurality of corrugated hollows.

Technical Solution

In accordance with another aspect of the present invention, there is provided planar inverted F antenna having a radiation patch, including: a first radiation patch for radiating a signal; a ground plate for grounding the first radiation patch; a feeding line for supplying an electric power to the first radiation patch; a short plate having one side coupled to the first radiation patch and other side coupled to the ground plate for shorting the first radiation patch, wherein the first radiation patch having an asymmetrical shape of linearly tapered rectangle and has one or more corrugated hollows.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a diagram illustrating a conventional planar inverted F antenna in accordance with a prior art;

FIG. 2 is a diagram illustrating a planar inverted F antenna in accordance with a preferred embodiment of the present invention; and

FIG. 3 is a diagram showing a planar inverted F antenna in accordance with another preferred embodiment of the present invention.

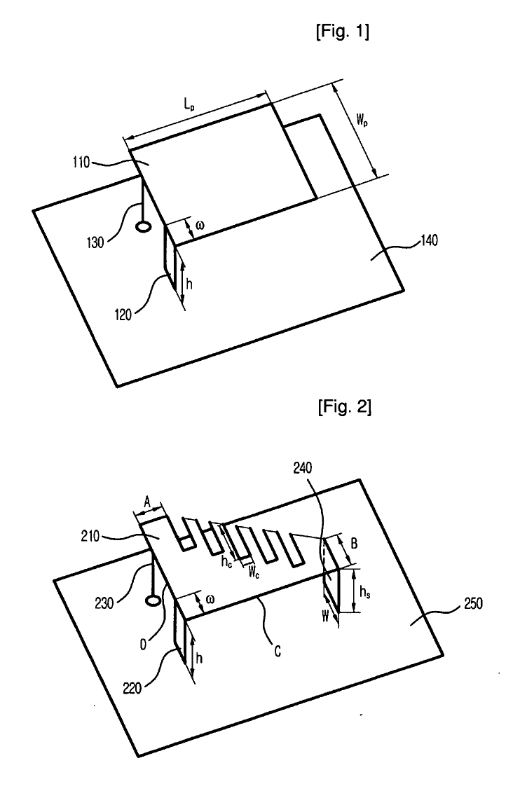

### BEST MODE FOR CARRYING OUT THE INVENTION

Hereinafter, a planar inverted F antenna in accordance with a preferred embodiment of the present invention will be described in more detail with reference to the accompanying drawings.

FIG. 2 is a diagram illustrating a planar inverted F antenna in accordance with a preferred embodiment of the present invention.

As shown in FIG. 2, the planar inverted F antenna 200 includes a radiation patch 210, an additional radiation patch 240, a shorting plate 220, a feeding line 230 and a grand plate 250.

The shorting plate 220 is equipped in between the ground plate 250 and the radiation patch 210. One side of the shorting plate 220 is coupled to the radiation patch 210 and other side of the shorting plate 220 is coupled to the ground pate 250. The shorting plate 220 has a function to short the radiation patch 210.

The feeding line 230 connected to the radiation patch 210 through the ground plate 250 has a function to supply electric power to the radiation patch 210.

The radiation patch 210 of the present invention is an asymmetrical shape of linearly tapered rectangle having a plurality of corrugated hollows along with a tapered line and each of the corrugated hollows has a predetermined length h_{c} and a predetermined width w_{c}. By providing the asymmetrical shape of linearly tapered rectangle having a plurality of corrugated hollows, a frequency bandwidth of the antenna is widened.

Generally, various paths of electric current must be included on the radiation patch for widening the frequency bandwidth of the antenna. That is, various frequencies of electric current must be resonated on the radiation patch. In the present invention, the radiation patch 210, which is the asymmetrical shape of linearly tapered rectangle, indices various paths of electric current comparing to a square shape of a conventional antenna. Accordingly, the frequency bandwidth of the antenna is widened.

In the present invention, a length of A or B of the radiation patch 210 are determined according to desired resonant frequency. Also, a ratio of taper in the radiation patch 210 is determined according to the desired resonant frequency.

Furthermore, a plurality of the corrugated hollows makes a length of current path following along the radiation patch 210 longer. That is, it makes electrical length of the radiation patch longer.

The number of the corrugated hollows formed on the radiation patch 210, the length h_{c} and the width w_{c} are determined according to the desired resonant frequency. Furthermore, a plurality of the corrugated hollows have different length h_{c} and the width w_{c}.

The additional radiation patch 240 extends the electrical length of the radiation patch 210. The additional radiation patch 240 is coupled at one side of the radiation patch 210 which is opposite end having the shorting plate 220. A length hₛ of the additional radiation patch 240 must be shorter than the length h of the radiation patch 210. Also, the length hₛ and a width wₛ of the additional radiation patch 240 are determined according to the desired resonant frequency.

The shorting plate 220 has a predetermined length h and width w for adjusting the desired resonant frequency and the shorting plate 220 can be coupled either of a length side C and a width side

[symbol]

of the radiation patch 210.

The feeding line 230 can be arranged any side of the radiation patch 210. In the preferred embodiment of the present invention in FIG. 2, the feeding line 230 is directly coupled to the radiation patch 210 which is a probe method of feeding line and however, it can be coupled to the radiation patch according to a coupling method.

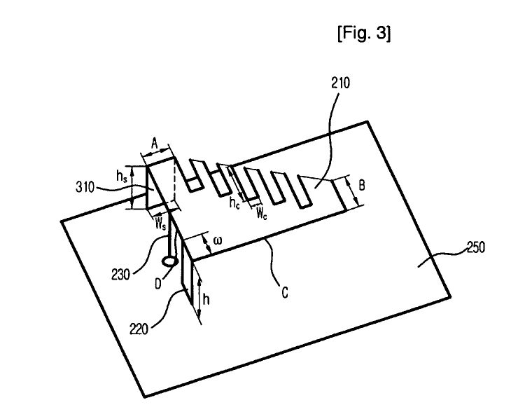

FIG. 3 is a diagram showing a planar inverted F antenna in accordance with another embodiment of the present invention.

As shown in FIG. 3, the planar inverted F antenna 300 has a structure identical to the planar inverted F antenna 200 in FIG. 2 excepting a location of an additional radiation patch 310. The additional radiation patch 310 is coupled to a length side A of the radiation patch 210 having an asymmetric shape of linearly tapered rectangular having a plurality of corrugated hollows. Since the other structure of the planar inverted F antenna 300 is same to the planar inverted F antenna 200 in FIG. 2, detailed descriptions of the planar inverted F antenna 300 are omitted.

As mentioned above, the present invention can widen the frequency bandwidth of the planar inverted F antenna by shaping a radiation patch having an asymmetric shape of a linearly tapered rectangle and forming a plurality of corrugated hollows on the radiation patch.

Also, the present invention can provide longer electrical length comparing to similar size of conventional antenna by a planar inverted F antenna having a linearly tapered rectangle shape of radiation patch having a plurality of corrugated hollows and additional radiation patch.

Furthermore, the present invention can be implemented in various application fields by providing a linearly tapered rectangle shape of radiation patch having a plurality of corrugated hollows in a planar inverted F antenna.

The present invention contains subject matter related to Korean patent application No. KR 2003-0072082, filed in the Korean patent office on Oct. 16, 2003, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A planar inverted F antenna having a radiation patch, comprising:
a first radiation patch for radiating a signal;
a ground means for grounding the first radiation patch;
a feeding means for supplying an electric power to the first radiation patch; and
a short means having one side coupled to the first radiation patch and other side coupled to the ground means for shorting the first radiation patch, wherein the first radiation patch is an asymmetrical shape of linearly tapered rectangle and has one or more corrugated hollows.

2. The planar inverted F antenna of claim 1, further comprising a second radiation patch coupled to one of a length side and a width side of the first radiation patch for extending an electrical length of the first radiation patch.

3. The planar inverted F antenna of claim 2, wherein the second radiation patch has a length shorter than the length of the first radiation patch.

4. The planar inverted F antenna of claim 3, the length and a width of the second radiation patch are determined according to a desired resonant frequency.

5. The planar inverted F antenna of claim 4, wherein a ratio of taper in the first radiation patch, the number of corrugated hollows, the predetermined length and width of the corrugated hollows are determined according to the desired resonant frequency.
